(19) United States
(12) Patent Application Publication
(10) Pub. No.: US 2013/0319260 A1
(43) Pub. Date: Dec. 5, 2013

(54) EGG WHITE-YOLK SEPARATOR DEVICE

(71) Applicant: Jeffrey NASRALLAH, Honolulu, HI (US)

(72) Inventor: Jeffrey NASRALLAH, Honolulu, HI (US)

(21) Appl. No.: 13/482,994

(22) Filed: May 29, 2012

(51) Int. Cl. A47J 43/14

(52) U.S. Cl. 99/497

(57) ABSTRACT

An egg white-yolk separator device has a plurality of yolk trays clustered in a symmetrical configuration centered around a cracking dome. Each yolk tray is surrounded by a dividing wall and ringed by a single annular straining channel for pouring off the egg white from the yolk except where a connecting arm extended from a center support member to the bottom side of the yolk tray. In one embodiment, the device has supporting legs on the outer sides of the yolk trays so that it can stand on a flat surface or be aligned on the rim of a bowl. In another embodiment, the device has ears or tabs on the outer sides of the yolk trays for alignment on the rim of a bowl while being self-standing on a flat pan by the bottoms of the yolk trays.

### BACKGROUND OF THE INVENTION

The invention relates to an egg white and egg yolk separator. Egg white (also know as albumen) consists of four alternating layers of thick and thin albumen containing approximately 40 different proteins. Egg whites are a well known and commonly used source for high quality protein in food recipes by athletes and health conscious individuals.

A common procedure for separating egg white from the yolk is a timely and tedious manual separation process. The most common and widely practiced process for egg white separation entails cracking the egg and separating the egg shell into two halves. In one half of the egg shell, the yolk and some egg white settle by gravity on one side, and the other half holds the remaining egg white. The shell that contains only egg white is then emptied into a bowl that is situated below and then the yolk from the one shell half is gently passed into the emptied egg shell half as the remaining egg white becomes slowly separated from the yolk. The yolk is then poured back and forth between egg shell halves in an attempt to separate out all of the egg white. After many times of shifting the yolk back and forth between the two halves of the egg shell, all the egg white will be separated from the yolk and all that will remain in one egg shell half is the yolk which can then be discarded. This process is then repeated for each egg for which egg white separation is desired. The total time required to separate one egg white using this manual technique depends on the skill and dexterity of the person performing the separation.

Drawbacks of the manual separation technique are the long time requirement, the high possibility of rupturing the yolk during the separation process, and the added clean up of the bowl used to collect the separated egg whites. Bakers only need a few egg whites for a cake or pastry recipe, therefore the manual separation technique may be suitable. However, for a health conscious individual that desires to consume numerous egg whites multiple times per week, this manual process is time consuming and sometimes frustrating. Often times during the manual separation process the yolk is punctured on the edge of the egg shell as the yolk is being passed back and forth between the egg shells, and the yolk becomes mixed with egg white and/or dripped into the egg white collection container.

There is a need for an egg white separating device that can quickly separate multiple egg whites at one time while still being circumferentially small enough to fit within a typical sized frying pan or over a common sized soup bowl or cereal bowl. Also there is a need for the egg white separating device to require minimal precision and effort on behalf of the user and can consistently separate the egg white from the yolk without rupturing the yolk. Also there is a need for an egg white separating device that can perform the separation process directly over a heated frying pan while expediting the separation process and allow the egg whites to separate from the yolk directly into a heated frying pan. This would also eliminate the need for excessive clean-up of a separate egg white collection container. Furthermore, there is a need for a means of cracking the shell of an egg on the separating device without breaking off shell fragments from the cracked shell.

### SUMMARY OF THE INVENTION

In accordance with the present invention, an egg white-yolk separator device comprises a plurality of individual yolk trays clustered around an egg-cracking dome in a symmetrical array, and is dimensioned to fit within the contour of a typical kitchen frying pan and on the rim of a typical dinnerware bowl or cereal bowl. Each yolk tray is centered within and surrounded by a dividing wall and ringed by a single annular straining channel for pouring off egg white from yolk poured into the respective yolk tray. A connecting arm extends from each dividing wall in a smooth curve and is cantilevered radially to support the bottom side of each yolk tray.

In one embodiment, the egg yolk separator device is supported on a plurality of supporting legs so that it can stand on its own on a flat pan surface or be aligned on the rim of an egg white receiving bowl. The legs may be encased in heat-resistant silicone casings to allow the device to be placed directly on top of a heated pan without causing heat-damage to the device. In another preferred embodiment, the egg yolk separator device does not have legs but has tabs or ears for alignment on the rim of a bowl and is self-standing on a pan surface by the bottom sides of the yolk trays.

The configuration of the connecting arms as multiple individual members supporting the respective yolk trays permit the separated egg whites to pass down from the annular straining channels to spread out and flow in between and beyond the footprint of the ends of the arms. This increases the speed of both the separation process and the egg white cooking time on a flat surface of a heated frying pan. The individually cantilevered connecting arms supporting the yolk trays also reduce the amount of egg white that may become stuck when flowing down to the pan or bowl.

Each egg-white straining channel spans around nearly the entire circumference of each yolk tray and thus greatly speeds up the separation flow of the egg white from the egg yolk. The egg white pours over and through the straining channel as a single unbroken fluid mass and flows downward to the lower point of the underside of the yolk tray at an increasingly faster rate. The more egg white that passes through the straining channel and flows downward, the more surface tension forces pull by weight on the remaining connected egg white through the straining channel so that the remaining mass pulls free cleanly from the egg yolk.

On the underside of the connecting arm supporting each yolk tray, the arm wall thickness may be thicker to provide greater support to the yolk tray. Preferably, the connecting arm thickens at the mid point of its entire length and tapers down in thickness to its end to form a smooth contour and blend in with the bottom surface of the yolk tray.

The cracking dome is provided on top of the device in the center of the yolk tray cluster. It is designed with a hard domed surface so as to crack an egg shell without puncturing the egg membrane and causing shell fragments to disconnect from the egg membrane and become mixed in with the liquid egg contents. The yolk tray is dimensioned to contain the typical volume of an egg yolk while displacing the egg white so that it pours through the opening of the straining channel from the yolk.

The egg white separator device is preferably molded from a plastic material that has a high heat resistance at or above 400 degrees F. In the embodiment with legs, use of a plastic material with high heat resistance would eliminate the need for silicone coverings for the legs. In the embodiment without legs, use high heat resistant plastic would allow the separator to be placed directly on top of the cooking surface of a hot pan.

### BRIEF DESCRIPTION OF DRAWINGS

FIG. 1 shows a plan view of an embodiment of an egg white-yolk separator device having supporting legs.

FIG. 2 shows a top perspective view of the embodiment of FIG. 1, FIG. 2A shows a side view taken along view lines A-A of the embodiment in FIG. 2, and FIG. 2B shows it a side view taken along view lines B-B in FIG. 2.

FIG. 3 shows a bottom view of the embodiment of FIG. 1.

FIG. 4 shows a bottom perspective view of the embodiment of FIG. 1.

FIG. 5A shows a top perspective view of the embodiment of FIG. 1 partially in section, and FIG. 5B shows the top perspective view in section from a left side angle.

FIG. 6 shows a plan view of another preferred embodiment of an egg white-yolk separator device without supporting legs.

FIG. 7 shows a top perspective view of the embodiment in FIG. 6.

FIG. 8 shows a side elevation view of the embodiment in FIG. 6.

FIG. 9 shows a bottom perspective view of the embodiment in FIG. 6.

FIG. 10 shows a top perspective view partially in section of the alternate embodiment with a modified design for the connecting arms supporting the yolk trays.

### DETAILED DESCRIPTION OF PREFERRED EMBODIMENTS

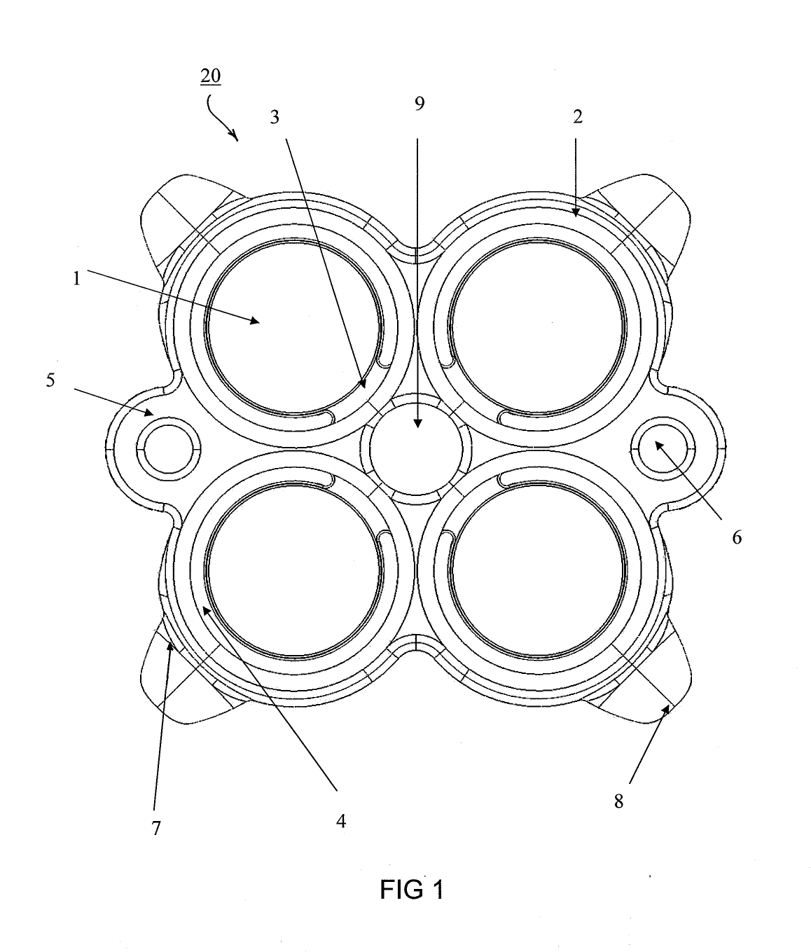

A first embodiment of an egg white-yolk separator device 20 for maximizing the speed and convenience of egg white-yolk separation in accordance with the present invention is shown in FIG. 1 having a plurality (4 in this embodiment) of individual yolk trays 1 clustered in a symmetrical configuration around a cracking dome 9 in their center. The dimensions of the separator device 20 are chosen to be small enough to fit within the contour of a typical kitchen frying pan and on the rim of a typical dinnerware bowl or cereal bowl. Each yolk tray 1 is ringed by a single egg white straining channel 4, which forms an annular slit opening slit surrounding nearly the entire circumference of the yolk tray 1. Each yolk tray 1 is centered within and surrounded circumferentially 360 degrees by a smooth-surfaced dividing wall 2, and is supported by a connecting arm 3 that extends from the dividing wall 4 under a bottom side of and cantilevered radially to support the yolk tray.

In this embodiment, the separator device 20 has a number of supporting legs 7 arranged on outer sides of the respective yolk trays and and extending downwardly therefrom. The legs are designed so that the device can stand on its own above a flat cooking surface, and also act as alignment features to ensure that the separator device 20 can be properly positioned on the rim of an egg white receiving bowl. The legs may be encased in heat-resistant silicone casings 8 to allow the device to be placed directly on top of a heated frying pan without causing heat-damage to the separator device 20.

The cracking dome 9 is incorporated into the separator design so that eggs can be cracked directly on top of the separator device 20 and the egg white and yolk poured into the yolk trays without making any countertop mess. The cracking dome has a hard domed surface designed to crack an egg shell without puncturing the egg membrane and causing shell fragments to disconnect from the egg membrane and become mixed in with the liquid egg contents.

Each yolk tray is dimensioned to contain the typical volume of an egg yolk while displacing the egg white so that it pours through the slit opening of the straining channel 4 in order to be separated from the yolk. The separator device 20 may be provided with a handle 5 on one side or on opposing sides of the device for convenience in lifting and positioning the device on a hot cooking pan or bowl. The handles 5 may be formed with a hanging hole 6 to allow the device to be hung as a kitchen utensil.

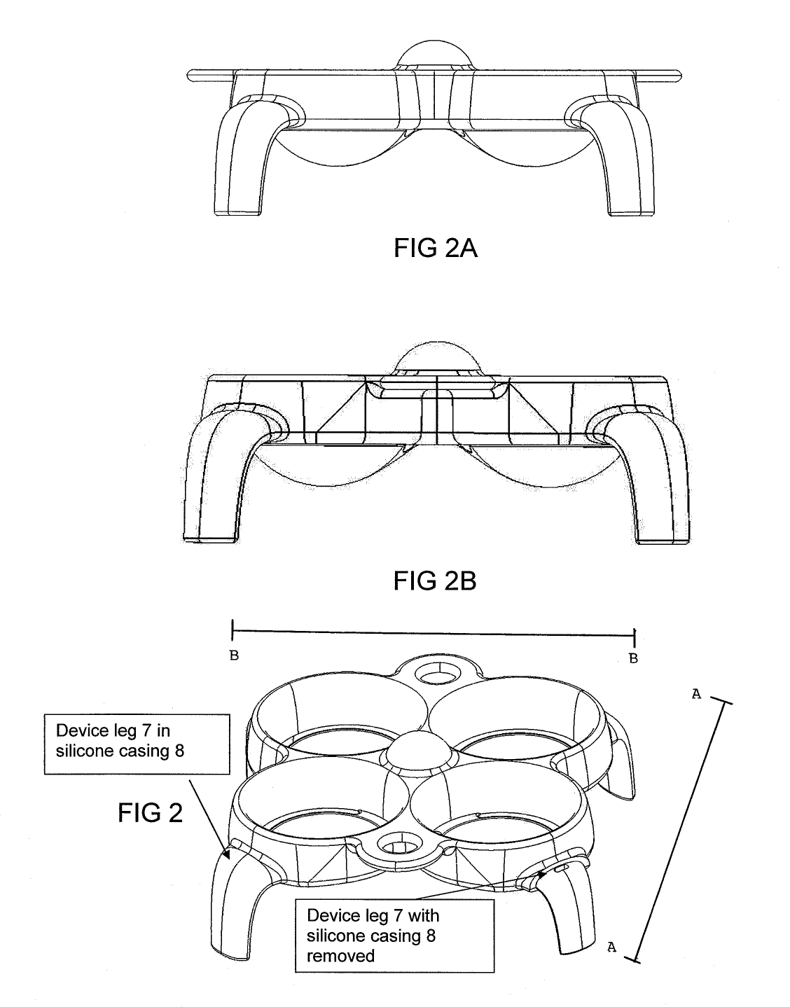

FIG. 2 shows the embodiment of FIG. 1 in perspective view with the device leg 7 in silicone casing 8 (left side of drawing), and with the silicone casing removed (right side).

FIG. 2A shows a side view taken along view lines A-A of the embodiment in FIG. 2, and FIG. 2b shows a side view taken along view lines B-B in FIG. 2.

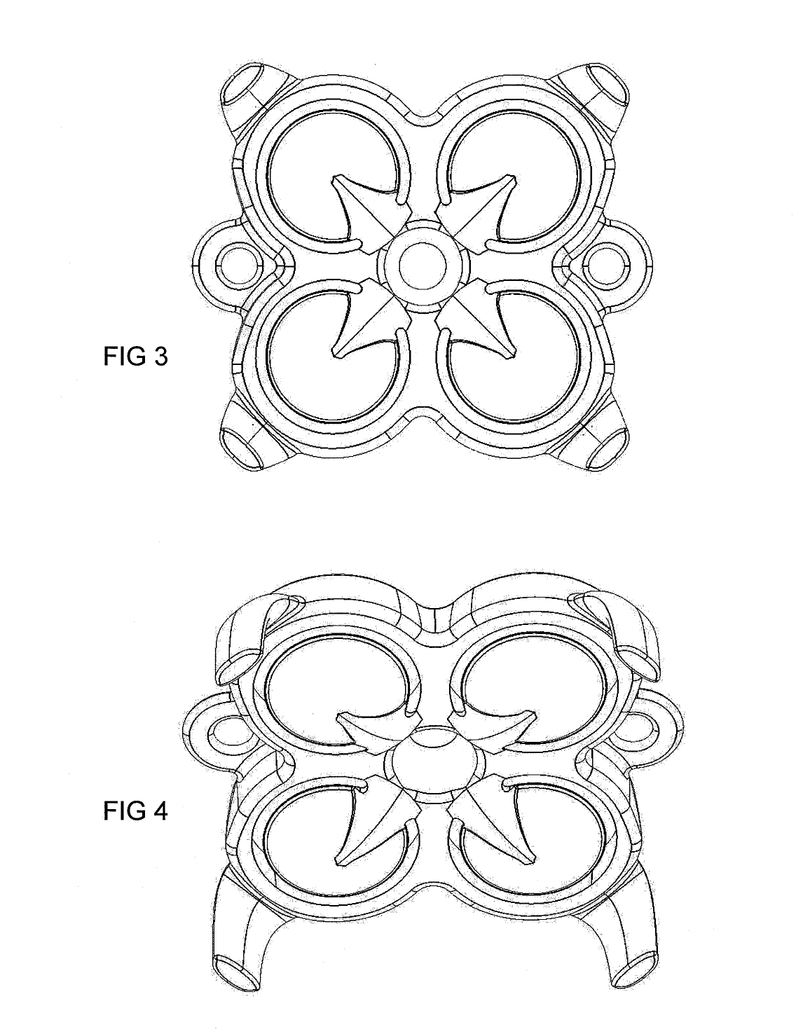

FIG. 3 shows a bottom view of the embodiment of FIG. 1, and FIG. 4 shows a bottom perspective view.

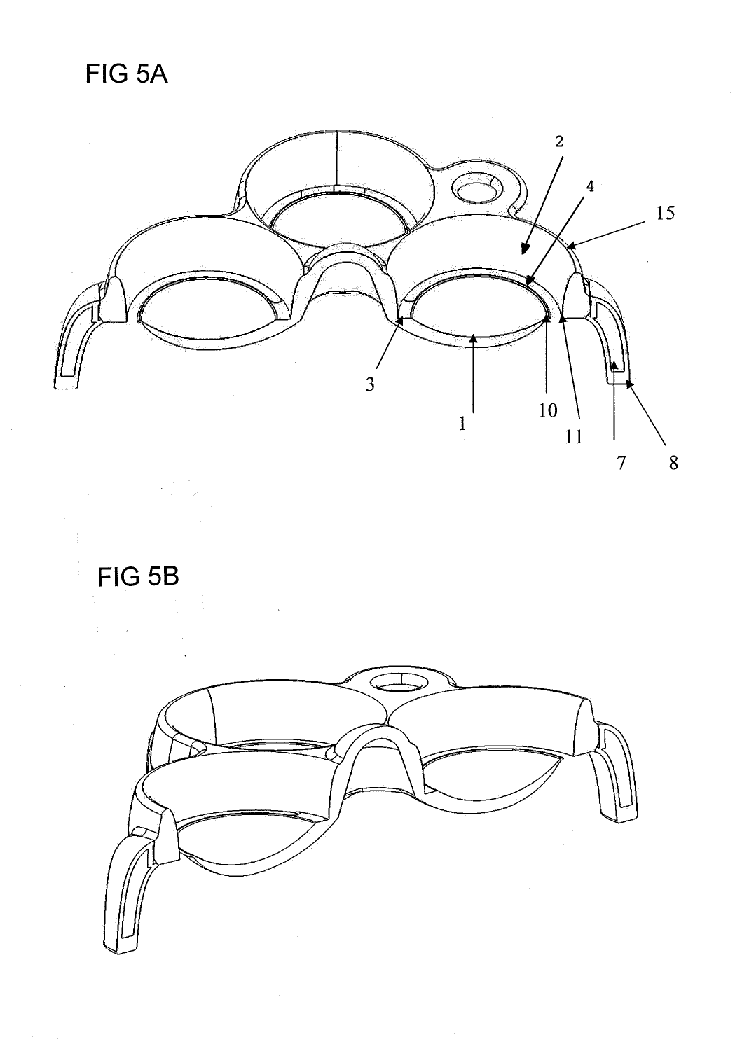

FIG. 5A shows a top perspective view of the embodiment of FIG. 1 partially in section, and FIG. 5B shows the top perspective view in section from a left side angle. Each yolk tray 1 is centered within and surrounded circumferentially 360 degrees by its dividing wall 2. Each yolk tray 1 is supported by a connecting arm 3 extending from a bottom part 11 of the dividing wall radially. The top surface of each connecting arm 3 is flush with a rim 10 of the yolk tray defining the surrounding channel 4. Once an egg is cracked and its contents are emptied into one of the four yolk trays contained by their dividing walls, the yolk sinks into and is held in the yolk tray 1 while the egg white pours over and into the surrounding straining channel 4. Each dividing wall contains an internal volume large enough to hold the entire contents of an extra large Grade A egg so that none spills over the top rim 15 of the dividing wall.

The yolk tray is designed with a smooth inner concave surface similar in circumference to an extra large Grade A yolk to cusp the yolk in a ball like position from beneath as well as circumferentially to minimize the stress on the Vitelline Membrane, which is the clear casing that encloses the yolk. The smooth concave surface of the yolk tray permits the egg yolk to be spun within the yolk tray without rupturing or tearing of the yolk. Spinning the yolk within the yolk tray is a method to expedite the separation process and displace any remaining egg white from the yolk tray into the straining channel 4.

The straining channel 4 is designed to be wide enough to allow the egg white to pass through but narrow enough to prevent the egg yolk from passing through. The straining channel 4 is designed as a single channel that wraps all the way around the yolk tray 1 except for the area formed by the connecting arm 3.

Because only a single connecting arm connects each yolk tray to the main body of the separator, a single, continuous straining channel spans around nearly the entire circumference of the yolk tray and greatly speeds up the separation process of the egg white from the egg yolk. The egg white pours over and through the straining channel as a single unbroken fluid mass and flows downward to the lower point of the underside of the yolk tray at an increasingly faster rate. The more egg white that passes through the straining channel and flows downward, the more surface tension forces pull by weight on the remaining connected egg white through the straining channel so that the remaining mass pulls free cleanly from the egg yolk. If a minor portion of the egg white remains connected to the yolk or resides within the yolk tray, manual manipulation of spinning the yolk within the tray will remove the remaining egg white from the yolk tray so it will passes through the straining channel.

The connecting arms for the respective yolk trays extend from an underside of the center support member in a smooth curve with their ends merging flush with the bottom sides of the yolk trays. The underside of the connecting arms may be thickened toward the midpoint of its length to provide greater support to the yolk tray. Preferably, the connecting arm tapers down in thickness to form a smooth contour at its end to blend in with the bottom surface of the yolk tray.

In the embodiment shown, the separator device 20 is formed with four yolk trays 1 arranged in a bi-axially symmetric cluster. The plurality of yolk trays are joined by a central support member on which the cracking dome is positioned in the center and to which one or more handles are coupled on the sides to enable a user to hold the separator and manually manipulate it for white-yolk separation. This enables a user to handle egg whites from up to four eggs at a time for a dish cooked in a pan or prepared in a bowl.

The four yolk trays 1 are positioned as close as possible to one another while still being able to incorporate a dividing wall 2 surrounding each yolk tray 1. The compressed layout of the four yolk trays 1 is circumferentially dimensioned to fit within or over typical sized household cooking instruments such as a frying pan or a dinner bowl or cereal bowl. The most common size frying pan used at home for cooking eggs has a 10″ diameter rim. The diameter inside the 10″ pan on the flat surfaced bottom area adjoining where the pan walls begin to curve upward is typically in the range of 7.0″ to 8.0″. The supporting legs of the separator device 20 are therefore kept within a 8.0″ diameter in order to sit flat on the bottom area of the frying pan. The handles 5 and other side extensions should also be kept at least 1″ away from the frying pan side walls so that it does not become too heated and risk the user being burned by the heated surface.

It is also desirable to have the egg separator device 20 fit over the common size of household dinnerware bowl or cereal bowl. Bowls commonly used at home have a typical inside diameter ranging from 5.75″ to 7.0″. The total outside diameter where the straining channels 4 of the separator device 20 discharge the egg white should therefore be no greater than 7.0″ so that the egg white can strain into the bowl below without dripping outside its edges.

The cracking dome 9 for cracking eggs is designed to have a hard rounded hemispherical surface that forms a crack in an egg without causing shell fragments to be formed and dislodged into the egg white or yolk. The rounded dome makes point contact with the oppositely rounded surface of the shell to form a crack and circular indentation without penetrating the egg membrane. The circular indention enables a thumb to be pressed into the indention if needed to gently penetrate the egg membrane and separate the egg shell into two halves. This produces superior results as compared to the common practice of cracking an egg on a sharp edged surface such as knife or the edge of a bowl, or by tapping two eggs against one another or hitting an egg with the back side of a spoon. The location of the cracking ball 9 on the center of the separator device 20 enables the force of cracking the egg to be distributed centrally so that it does not tip or tilt over and confines any liquid content to the collection surfaces of the device.

In the embodiment shown in FIG. 1, four supporting legs are respectively positioned on the outer side of the dividing wall of each of the four yolk trays. The legs enable the device to be placed on the flat bottom of a standard sized frying pan, and also can be aligned over the rim of an egg white collection bowl. The legs may be encased in heat-resistant silicone casings so that the separator device can be placed directly on a heated pan without damage occurring while egg whites are strained directly into the heated pan. The silicone casings can be formed by various methods, such as an over mold process, two shot molding, or the silicone parts can be made separately then snap fitted onto the separator legs. The handles 5 may also be encased in silicone. The hanging hole 6 formed in one or both holding arms allow the device to be hung in the kitchen as many kitchen utensils commonly are. The separator device is formed as an integral unit of heat-resistant plastic material that is dishwasher safe, easy to clean, and inexpensive to manufacture.

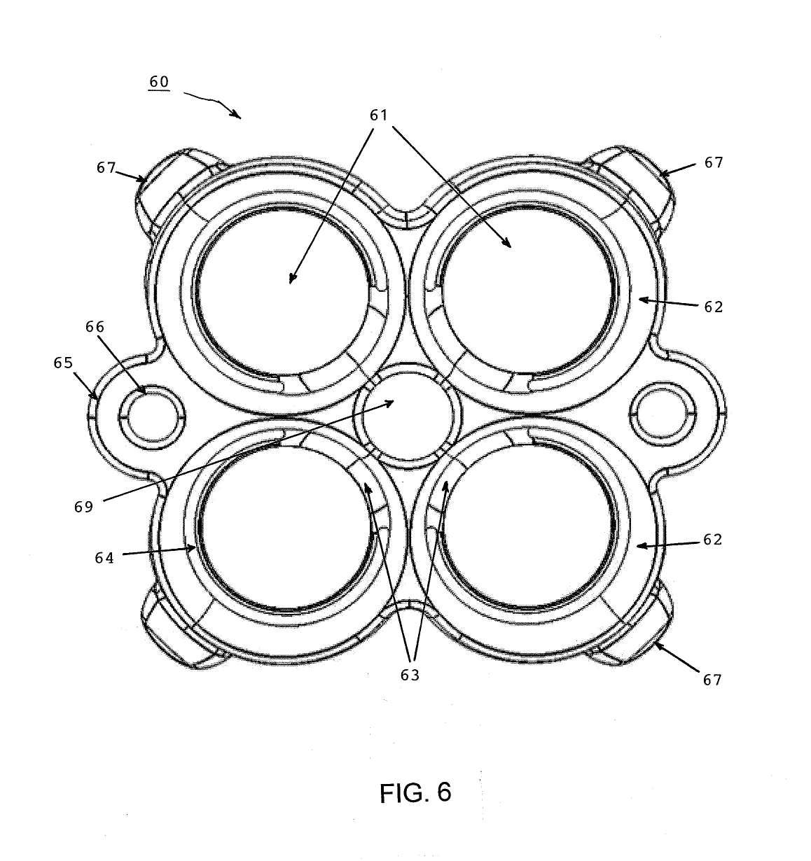

Another preferred embodiment of an egg white-yolk separator device 60 is shown in FIG. 6 having a plurality (4) of yolk trays 61 clustered in a symmetrical configuration, respective surrounding dividing walls 62, connecting arms 63, straining channels 64, side handles 65 with holes 66, and cracking dome 69 in the center of the yolk trays 61. This embodiment has no supporting legs but is instead provided with supporting ears or tabs 67 by which the device can be aligned to sit on the rim of a bowl. The bottom sides of the yolk trays in this embodiment are configured to allow it to sit directly on top of the cooking surface of a pan.

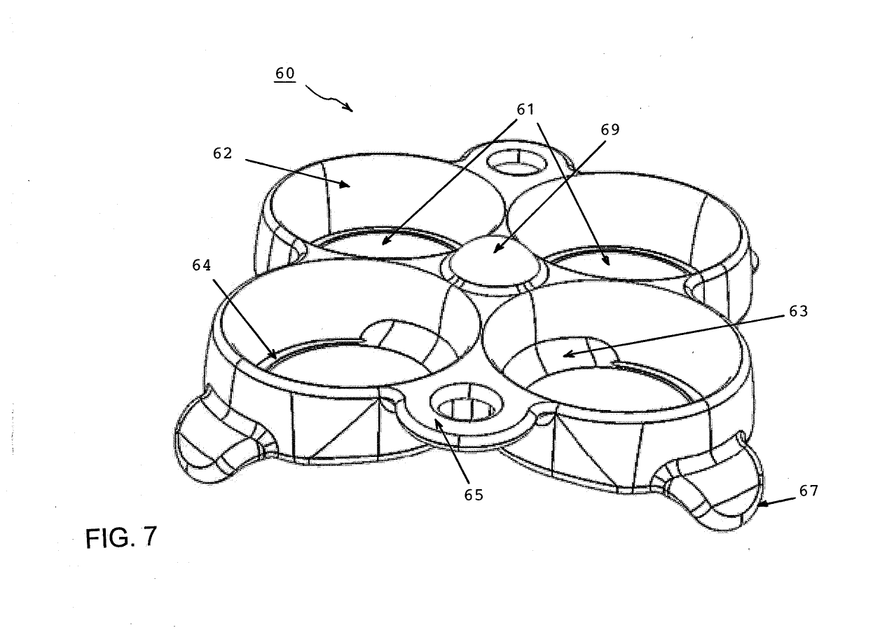

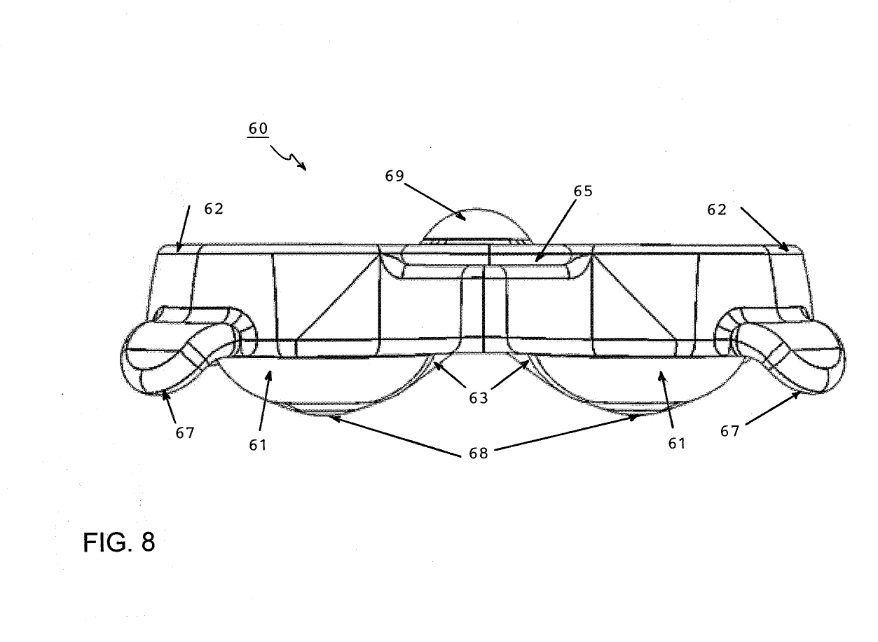

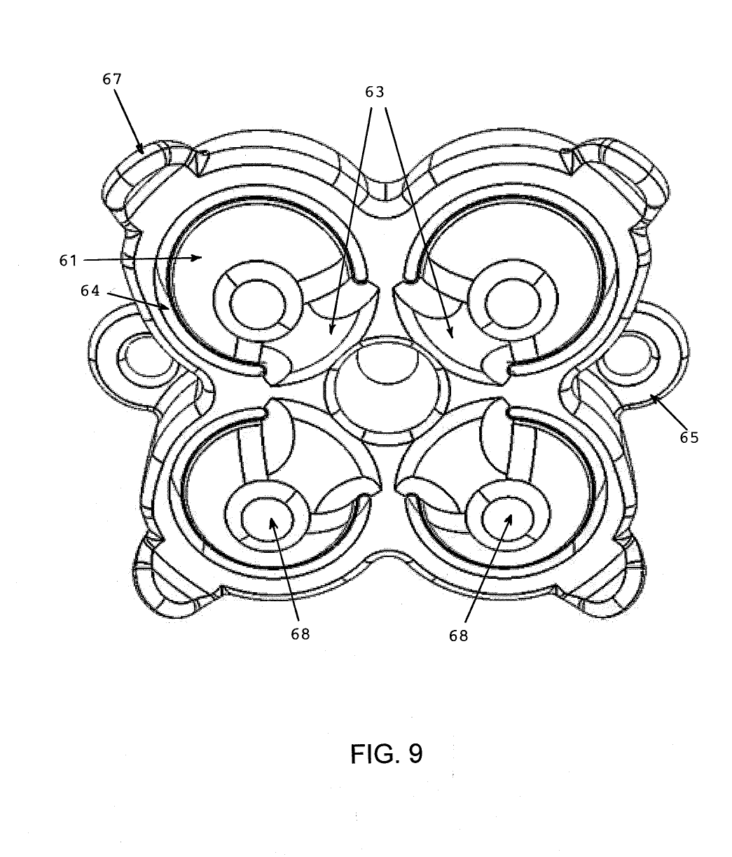

FIG. 7 shows a top perspective view, FIG. 8 shows a side elevation view, and FIG. 9 shows a bottom perspective view of the embodiment in FIG. 6. As shown most clearly in FIGS. 8 and 9, the bottom centers of the yolk trays 61 are molded with base portions 68 that are aligned in a horizontal plane with each other so that they can sit flat on the cooking surface of a pan. The connecting arms 63 extend from the underside of the center support member for the device in a smooth curve so that their ends merge flush with the base portions 68 of the yolk trays. The base portions 68 render the separator device self-standing on a pan, while the supporting ears or tabs 67 allow it to be placed in alignment on the rim of a bowl.

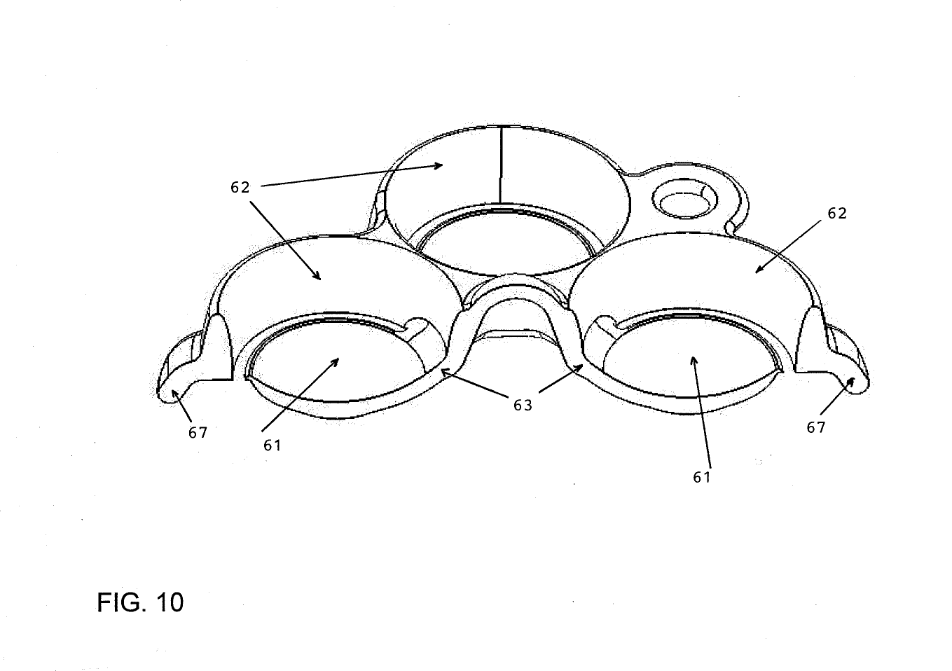

FIG. 10 shows a top perspective view partially in section of the alternate embodiment with a modified design for the connecting arms supporting the yolk trays. To make molding the arm structures easier, the top part of the connecting arm begins at the rim of the yolk tray and extends upward to blend in smoothly with the dividing wall. The configuration of the connecting arms 63 as multiple individual members smoothly merging with the base portions 68 permit separated egg whites to pass from the straining channels 64 and flow down and spread out beyond the footprint of the base portions 68. This increases the speed for both the separation process and cooking time when done on a flat heated frying pan. The smooth, flush configuration of the connecting arms 63 with the base portions 68 also reduces the amount of egg white that may become stuck to the underside of the device.

Preferably, the separator device is molded of a plastic material that has a high heat resistance of at least 400 degrees F. or more. The use of high heat-resistant plastic can simplify the molding process and eliminate the need for silicone coverings for lower parts placed in contact with a hot pan.

While certain preferred embodiments of the present invention have been described, it is to be understood that many modifications and variations may be devised given the above description of the general principles of the invention. For example, the number of yolk trays may be reduced to 3, or increased to 5 or 6 yolk trays. Certain structures and component members may be replaced by equivalently functioning parts or modified in different shapes or designs. Other materials may be used for fabrication of the device, such as heat-resistant ceramic or composite material. It is intended that all such modifications and variations be considered as within the spirit and scope of this invention, as defined in the following claims.

1. An egg white-yolk separator device comprising:
a plurality of yolk trays clustered in a symmetrical configuration around a center support member, wherein each yolk tray is centered within and surrounded by a dividing wall for containing liquid contents of an egg poured therein, and has a connecting arm extending from the respective dividing wall to a bottom side of each yolk tray for support thereof, and
wherein each yolk tray is ringed by a single annular straining channel extending around nearly an entire circumference thereof except for the connecting arm, said straining channel being open to the bottom side of the respective yolk tray for pouring off egg white from yolk to be contained in the yolk tray.

2. An egg white-yolk separator device according to claim 1, further comprising a plurality of supporting legs arranged on outer sides of the respective yolk trays and extending downwardly therefrom to enable the device to stand above a flat cooking surface as well as be aligned on the rim of an egg white receiving bowl.

3. An egg white-yolk separator device according to claim 2, wherein said legs are-encased in heat-resistant silicone casings.

4. An egg white-yolk separator device according to claim 1, further comprising a plurality of side tabs arranged on outer sides of the respective yolk trays to enable the device to be aligned over the rim of an egg white receiving bowl while being self-standing on a flat cooking surface by the bottom sides of the plurality of yolk trays.

5. An egg white-yolk separator device according to claim 1, further comprising a cracking dome provided on top of the center support member for the plurality of yolk trays, which has a hard rounded hemispherical surface designed to crack an egg shell without puncturing the egg membrane and causing shell fragments to disconnect from the egg membrane and become mixed in with the liquid egg contents.

6. An egg white-yolk separator device according to claim 1, further comprising one or more sidewardly extending handles for lifting and positioning the device.

7. An egg white-yolk separator device according to claim 6, wherein each sidewardly extending handle has a center hole for hanging up the device.

8. An egg white-yolk separator device according to claim 1, wherein the device is molded from a plastic material that has high heat resistance.

9. An egg white-yolk separator device according to claim 1, comprising four yolk trays respective surrounded by four dividing walls and arranged in a bi-axially symmetric cluster positioned in close proximity to one another.

10. An egg white-yolk separator device according to claim 9, comprising four supporting legs arranged on respective outer sides of the four yolk trays.

11. An egg white-yolk separator device according to claim 9, comprising four supporting tabs arranged on respective outer sides of the four yolk trays.

12. An egg white-yolk separator device according to claim 4, wherein the yolk trays have base portions on bottom centers thereof that are aligned in a horizontal plane with each other so that the device can sit flat on the cooking surface of a pan.

13. An egg white-yolk separator device according to claim 1, wherein the connecting arms each has a top part that begins at the rim of the yolk tray and extends upwardly to blend in smoothly with the dividing wall.

14. An egg white-yolk separator device according to claim 8, wherein the separator device is molded as a single unit from heat-resistant plastic material that is dishwasher safe, easy to clean, and inexpensive to manufacture.

15. An egg white-yolk separator device according to claim 1, wherein each yolk tray with its dividing wall is dimensioned to have a volume sufficient to contain liquid contents of a largest size of commercially sold egg.
